(19) United States
(12) Patent Application Publication
(10) Pub. No.: US 2010/0050310 A1
(43) Pub. Date: Mar. 4, 2010

(54) BALLISTIC RESISTANT SHEET AND BALLISTIC RESISTANT ARTICLE

(76) Inventors: Martin Antonius Van Es, Brunssum (NL); Marcel Jongedijk, Sittard (NL)

Correspondence Address: NIXON & VANDERHYE, PC, 901 NORTH GLEBE ROAD, 11TH FLOOR, ARLINGTON, VA, 22203, US

(21) Appl. No.: 12/520,655

(22) PCT Filed: Dec. 21, 2007
(86) PCT No.: PCT/EP07/11331

§ 371 Date: Nov. 9, 2009

(30) Foreign Application Priority Data
Dec. 22, 2006 (EP) 06026712.7

(51) Int. Cl. F41H 1/02; B32B 5/12

(52) U.S. Cl. 2/2.5; 428/113

(57) ABSTRACT

The present invention relates to a ballistic resistant sheet comprising a stack of at least 2 monolayers with on top hereof a polymeric film, each monolayer containing nidirectionally oriented reinforcing fibers or yarns with a tensile strength of between 3.5 an 4.5 GPa, and at most 20 mass % of a matrix material, the areal density of a monolayer is between 10 and 80 g/m² and with the fiber direction in each monolayer being rotated with respect to the fiber direction in an adjacent monolayer. The ballistic resistant sheet according to the invention may suitably be assembled together to form a ballistic resistant assembly or a ballistic resistant article. Such ballistic resistant article may be used as, for example, protective clothing and bullet resistant vests offering protection against ballistic impacts such as bullets and ballistic fragments.

The present invention relates to a ballistic resistant sheet and a ballistic resistant article.

A ballistic resistant sheet comprising a stack of at least 2 monolayers with on top hereof a polymeric film, each monolayer containing unidirectionally oriented reinforcing fibers with at most 20 mass % of a matrix material, and with the fiber direction in each monolayer being rotated with respect to the fiber direction in an adjacent monolayer.

Such a ballistic resistant sheet is known from EP 0907504 A1. This reference describes a ballistic resistant sheet, which was produced by cross-wise stacking of 4 monolayers to obtain a stack and applying a separating film made from a linear low-density polyethylene, and subsequently consolidating the stack at elevated temperature under pressure. The mono-layers containing unidirectionally oriented fibers were produced by aramid yarn being guided from a bobbin frame over a comb and wetting them with a dispersion of a polystyrene-polyisoprene-polystyrene blockcopolymer as a matrix material. Flexible ballistic resistant articles were made from a non-linked pile of several of said ballistic resistant sheets, the pile being stabilized by stitching at the corners.

Although further improvements are becoming increasingly difficult, the industry is constantly looking for improved ballistic resistant articles and a need exists for articles with good ballistic resistance combined with good flexibility. Such combination of properties is especially beneficial in protective garments.

Surprisingly such an article is obtained, if the article comprises one or more ballistic resistant sheets of the present invention comprising a stack of at least 2 monolayers with on top hereof a polymeric film, each monolayer containing
unidirectionally oriented reinforcing fibers with a tensile strength of between 3.5 an 4.5 GPa,
and at most 20 mass % of a matrix material,
the areal density of a monolayer is between 10 and 80 g/m²
and with the fiber direction in each monolayer being rotated with respect to the fiber direction in an adjacent monolayer.

The ballistic resistant sheet according to the invention provides good anti-ballistic performance combined with good flexibility of the ballistic resistant article. This makes the ballistic resistant sheet according to the invention very suitable for use in e.g. protective clothing, such as bullet resistant vests, offering protection against ballistic impact from bullets and fragments.

An additional advantage is that e.g. a police officer wearing such improved bullet resistant vest is more mobile and thus better able to defend himself in a close combat. This results in an increased survivability.

In the present invention the term monolayer refers to a layer of unidirectionally oriented reinforcing fibers and a matrix material that basically holds the fibers together.

A ballistic resistant sheet comprises a stack of at least 2 monolayers, preferably the at least two monolayers and the polymeric film being linked or attached to one another. The monolayers are stacked in such a way that the fiber direction in each monolayer being rotated with respect to the fiber direction in an adjacent monolayer. The angle of rotation, which means the smallest angle enclosed by the fibers of the adjacent monolayers is preferably between 0° and 90° , more preferably between 100 and 800. Most preferably the angle is between 450 and 90°.

A polymeric film is positioned on top of the stack. In a preferred embodiment the polymeric film is also positioned on the bottom side of the stack, i.e. on both of the outer surfaces of the stack.

The polymeric film preferably has an areal density of between 1 and 10 g/m². Said film may be for example a polyolefin such as e.g. polyethylene or polypropylene, a polyester, a polyamide, a polycarbonate or a polystyrene film. The polymeric film is a preferably made from a polyolefin -more preferably a polyethylene or a polypropylene—a polyester—especially a thermoplastic polyester or a polycarbonate. In a preferred embodiment, the polymeric film is essentially made from a high molar mass polyethylene, more preferably form an ultra-high molar mass polyethylene of intrinsic viscosity of at least 4 dl/g. Such a film may be produced according to a process as disclosed in GB2164897. Such films show generally relatively high strength and modulus, and high abrasion resistance.

The fibers, or yarns, in the ballistic resistant sheet of the invention have a tensile strength of between 3.5 and 4.5 GPa. The fibers may be inorganic or organic fibers. Suitable inorganic fibers are, for example, glass fibers, carbon fibers and ceramic fibers.

Suitable organic fibers with such a high tensile strength are, for example, aromatic polyamide fibers (also often referred to as aramid fibers), especially poly(p-phenylene teraphthalamide), liquid crystalline polymer and ladder-like polymer fibers such as polybenzimidazoles or polybenzoxazoles, esp. poly(1,4-phenylene-2,6-benzobisoxazole) (PBO), or poly(2,6-diimidazo[4,5-b-4′,5′-e]pyridinylene-1,4-(2,5-dihydroxy)phenylene) (PIPD; also referred to as M5) and fibers of, for example, polyolefins, polyvinyl alcohol, and polyacrylonitrile which are highly oriented, such as obtained, for example, by a gel spinning process. The fibers preferably have a tensile strength of between 3.6 and 4.3 GPa, more preferably between 3.7 and 4.1 GPa or most preferably between 3.75 and 4.0 GPa. Highly oriented polyolefin, aramid, PBO and PIPD fibers, or a combination of at least two thereof are preferably used.

High performance polyethylene fibers consisting of polyethylene filaments that have been prepared by a gel spinning process, such as described, for example, in GB 2042414 A or WO 01/73173, are even more preferably used. The advantage of these fibers is that they have very high tensile strength combined with a light weight, so that they are in particular very suitable for use in lightweight ballistic resistant articles.

Most preferably, use is made of multifilament yarns of ultra-high molar mass linear polyethylene with an intrinsic viscosity of at least 5 dl/g.

The titer of a single filament of these fibers or yarns preferably is at most 2 denier, more preferably the titer of a single filament of these fibers is at most 1.9 denier. This results in a better mouldability of the ballistic resistant sheet. Most preferably the titer of a single filament of these fibers is at most 1.8 denier.

The term matrix material refers to a material that binds or holds the fibers together and may enclose the fibers in their entirety or in part, such that the structure of the mono-layer is retained during handling and making of preformed sheets. The matrix material can have been applied in various forms and ways; for example as a film between monolayers of fiber, as a transverse bonding strip between the unidirectionally aligned fibers or as transverse fibers (transverse with respect to the unidirectional fibers). It is also possible to impregnate and/or to embed the fibers with a matrix material.

In a preferred embodiment, the matrix material is a polymeric matrix material, and may be a thermosetting material or a thermoplastic material, or mixtures of the two. The elongation at break of the matrix material is preferably greater than the elongation of the fibers. The matrix material preferably has an elongation of 3 to 500%. In another preferred embodiment, the matrix material is a polymeric matrix material preferably has an elongation of at least 200%, more preferably from 300 to 1500%, more preferably from 400 to 1200%. From the group of thermosetting materials, vinyl esters, unsaturated polyesters, epoxies or phenol resins are preferably selected as matrix material. From the group of thermoplastic materials, polyurethanes, polyvinyls, polyacrylics, polyolefins and thermoplastic elastomeric block copolymers such as polyisopropene-polyethylene-butylene-polystyrene or polystyrene-polyisoprene-polystyrene block copolymers are preferably selected as matrix material. More preferably the matrix material is a thermoplastic elastomer, which preferably substantially coats the individual filaments of said fibers in a monolayer, and has a tensile modulus (determined in accordance with ASTM D638, at 25° C.) of less than about 40 MPa. Such a matrix material results in high flexibility of a monolayer, and of an assembly of preformed sheets. It was found that very good results are obtained if the matrix material in the monolayers and preformed sheet is a styrene-isoprene-styrene block copolymer.

The amount of matrix material in the monolayer is at most 20 mass %. This results in a good combination of anti-ballistic performance and flexibility. Preferably the amount of matrix material in the monolayer is at most 18.5%; more preferably at most 17.5 mass %. This results in an even better combination of anti-ballistic performance and flexibility. Most preferably the amount of matrix material in the monolayer is at most 16 mass %. This results in the best combination of anti-ballistic performance and flexibility.

It was found that in order to achieve the required combination of ballistic resistance and flexibility the weight, or areal density (AD), of the monolayer has to be between 10 and 100 g/m². Preferably, the weight of the monolayer is between 15 and 80 g/m². More preferably, the weight of the monolayer is between 20 and 60 g/m².

In order to prevent deterioration of the flexibility of the ballistic resistant sheet according to the invention the number of monolayers in the ballistic resistant sheet is preferably at most 10. More preferably the number of monolayers in the ballistic resistant sheet is at most 8. Most preferably the number of monolayers in the ballistic resistant sheet is at most 6.

For the manufacture of the ballistic resistant sheet according to the invention, the unidirectionally reinforcing fibers are impregnated with the matrix material for instance by applying one or more plastic films to the top, bottom or both sides of the plane of the fibers and then passing these, together with the fibers, through heated pressure rolls. Preferably, however, the fibers, after being oriented in parallel fashion in one plane, are coated with an amount of a liquid substance containing the matrix material. The advantage of this is that more rapid and better impregnation of the fibers is achieved. The liquid substance may be for example a solution, a dispersion or a melt of the plastic. If a solution or a dispersion of the plastic is used in the manufacture of the monolayer, the process also comprises evaporating the solvent or dispersant. In this way a monolayer is obtained. Subsequently at least 2 of such monolayers are stacked in such a way that the fiber direction in each monolayer being rotated with respect to the fiber direction in an adjacent monolayer. Finally the stacked monolayers and the polymeric film are given a treatment so that they are linked or attached to one another. A suitable method may be pressing or calendaring the stack at a temperature sufficiently high to obtain adhesion between the monolayers and the polymeric film. Generally a higher temperature will give a better adhesion. The adhesion may be further increased by applying some pressure. Suitable pressure and temperature can be found by some routine experimentation. In the event of high performance polyethylene fibers such temperature may not exceed 150° C.

The ballistic resistant sheet according to the invention may suitably be used in a ballistic resistant assembly or a ballistic resistant article. With ballistic resistant articles are meant shaped parts, comprising a pile of at least two ballistic resistant sheets according to the invention, which may be used as, for example, protective clothing and bullet resistant vests offering protection against ballistic impacts such as bullets and ballistic fragments.

Such assembly according to the invention contains a stack of ballistic resistant sheets that are preferably substantially not linked to one another; that is, the sheets are not attached or adhered to each other over at least 90% of their adjacent surfaces. More preferably an assembly according to the invention contains a stack of ballistic resistant sheets that are not linked to one another. It is, however, difficult to handle a stack of preformed sheets that are not linked to one another, because such stack lacks any coherence required for further processing. To achieve some level of coherence, the ballistic resistant article may, for example, be stitched through. Such stitching is done as little as possible, for example only at the corners or around the edges, in order to allow movement of sheets relative to each other. Another possibility is to enclose the stack of preformed sheets in a flexible cover or envelop. Thus the preformed sheets in the assembly or in the ballistic resistant article remain able to shift with respect to one another, whereas the assembly or article in itself does have coherence and shows good flexibility.

The invention further relates to an assembly of at least two ballistic resistant sheets according to the invention. Preferably the sheets are substantially not linked to one another. With increasing number of ballistic resistant sheets, the ballistic protection level is improved, but the weight of the assembly increases, and the flexibility decreases. For the assembly to have an optimum combination of ballistic resistance and flexibility the number of ballistic resistant sheets in the assembly is between 10 and 250, more preferably between 15 and 225 and most preferably between 20 and 200.

In order to obtain a maximum flexibility, adjacent sheets in such an assembly are not linked to one another. However, to achieve some level of coherence the assembly of preformed sheets may, for example, be stitched through.

Finally the invention relates to a protective garment, such as a bullet resistant vest, comprising the ballistic resistant sheet of the invention.

### Test Methods as Referred to in the Present Application, are as Follows:

IV: the Intrinsic Viscosity is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration;
Tensile properties (measured at 25° C.): tensile strength (or strength), tensile modulus (or modulus) and elongation at break (or eab) are defined and determined on multifilament yarns as specified in ASTM D885M, using a nominal gauge length of the fiber of 500 mm, a crosshead speed of 50%/min. On the basis of the measured stress-strain curve the modulus is determined as the gradient between 0.3 and 1% strain. For calculation of the modulus and strength, the tensile forces measured are divided by the titre, as determined by weighing 10 metres of fiber; values in GPa are calculated assuming a density of 0.97 g/cm³. Tensile properties of thin films were measured in accordance with ISO 1184(H).

The invention shall now be further elucidated with the following example and comparative experiments, without being limited thereto.

### EXAMPLE 1

First a unidirectional monolayer was made on a drum winder. To this end a siliconised paper was attached to the drum of the drum winder. The drum had a circumference and width that were both 160 cm. A high performance polyethylene yarn with a tenacity of 3.6 GPa and a titer of 1.92 denier per filament was wound on the drum winder with a pitch of 6.1 mm. Before being wound on the drum the yarn was wetted with a dispersion of a Styrene Isoprene Styrene block copolymer in water. By diluting the dispersion the amount of solids taken up by the yarn was adjusted to 18 wt % with respect to the amount of yarn, i.e. 18wt % of matrix material.

All water was evaporated by heating the drum to about 65° C. In doing so a monolayer was made with an areal density (AD) of 29.8 g/m² (i.e. a yarn areal density of 24.6 g/m²).

Before adding the second monolayer, the first monolayer was removed from the drum, turned 90° and again attached to the drum. Using the same procedure a second monolayer was adhered to the first monolayer by winding yarn on the drum. The yarns of the second layer are oriented essentially perpendicular to the yarns in the first monolayer. This procedure was repeated to add a third and fourth monolayer.

The obtained sheet consisted of 4 monolayerlayers oriented in a 0°/90°/0°/90° direction.

On both sides of this sheet a 8 μm thick LDPE film was attached. The areal density of the LDPE sheets was 7.5 gr/m2.

The so obtained final sheet, i.e. the ballistic resistant sheet according to the invention, had an AD of 134.1 g/m².

In total 37 of such final sheets having a size of 40×40 cm were stacked together, all attached in the edges by sewing. In this way a soft ballistic pack was made with an AD of 5.0 kg/m2 and a yarn AD of 3.6 kg/m2, as given in Table 1.

The obtained soft ballistic packs were subjected to shooting test in accordance with the procedure set out in STANAG 2920, with the use of 17 grain Fragment Simulating Projectiles, so-called FSP. During the shooting tests a Caran d'Ache Plastine backing for the soft ballistic packs was used. These tests were performed with the aim of determining a V50 and/or the energy absorbed.

V50 is the speed at which 50% of the projectiles will penetrate the soft ballistic pack. The testing procedure was as follows. The first projectile was fired at the anticipated V50 speed. The actual speed was measured shortly before impact. If the projectile was stopped, a next projectile was fired at an intended speed of about 10% higher. If the soft ballistic pack was perforated, the next projectile was fired at an intended speed of about 10% lower. The actual speed of impact was always measured. V50 was the average of the two highest stops and the two lowest perforations.

The performance of the armor was also determined by calculating the kinetic energy of the projectile at V50 and dividing this by the AD of the plate, the so-called ‘Eabs’.

The V50 of the soft ballistic pack was found to be 543 m/s, the Eabs was 45 J m²/kg.

### Comparative Experiment A

The same procedure was used as described in Example 1 to make a sheet, except a Dyneema® SK76 yarn was used with a tensile strength of 3.5 GPa and a titer of 2.3 denier per filament; the dispersion was diluted such that the amount of solids taken up by the yarn was 22 wt % with respect to the amount of yarn; the areal density of a monolayer was 100 g/m2; the sheet consisted of 2 monolayerlayers oriented in a 0°/90° direction and the LDPE films and had an areal density of 215 g/m2.

By stacking of the sheets a soft ballistic pack was made with an AD of 5.2 kg/m2 and a yarn AD of 3.8 kg/m2, i.e. 0.2 kg/m2 higher than the AD in Example 1.

The V50 of the soft ballistic pack was found to be 484 m/s and the Eabs was 34 J m²/kg.

### Comparative Experiment B

The same procedure was used as described in example 1 to make a sheet, except a Dyneema® SK76 yarn was used with a tensile strength of 3.5 GPa and a titer of 2.3 denier per filament; the dispersion was diluted such that the amount of solids taken up by the yarn was 18.7 wt % with respect to the amount of yarn; the areal density of a monolayer was 32.5 g/m2. The final sheet had an areal density of 145 g/m2

By stacking of the sheets a soft ballistic pack was made with an AD of 5.2 kg/m2 and a yarn AD of 3.8 kg/m2, i.e. 0.2 kg/m2 higher than the AD in Example 1.

The V50 of the soft ballistic pack was found to be 526 m/s and the Eabs was 40 J m²/kg.

TABLE 1

| | | Example 1 | Comp. A | Comp. B |
|---|---|---|---|---|
| Tensile strength yarn | [GPa] | 3.6 | 3.5 | 3.5 |
| # monolayers/sheet | [—] | 4 | 2 | 4 |
| Amount of matrix | [wt %] | 18.0 | 22.0 | 18.7 |
| AD yarn/monolayer | [g/m2] | 24.6 | 78.0 | 26.6 |
| AD monolayer | [g/m2] | 29.8 | 100.0 | 32.5 |
| AD/sheet | [g/m2] | 134.1 | 215.0 | 145.0 |
| # sheets per pack | | 37 | 24 | 36 |
| AD pack | [kg/m2] | 5.0 | 5.2 | 5.2 |
| Yarn AD in pack | [kg/m2] | 3.6 | 3.8 | 3.8 |
| V50 | [m/s] | 543 | 484 | 526 |
| Eabs yarn | Jm²/kg | 45 | 34 | 40 |

The above results show that even with a lower areal density of polyethylene fiber—which is seen as the effective component—in the ballistic resistant sheet and the soft ballistic packs according to the invention, the soft ballistic pack in Example 1 showed a significant higher Eabs of at least 13%. In the ballistic field this is seen as a very significant further improvement.

Not only are the sheets according to Example 1 lighter, they are also more flexible.

1. Ballistic resistant sheet comprising a stack of at least 2 monolayers with on top hereof a polymeric film,
each monolayer containing
unidirectionally oriented reinforcing fibers or yarns with
a tensile strength of between 3.5 and 4.5 GPa, and
at most 20 mass % of a matrix material,
the areal density of a monolayer is between 10 and 80 g/m²
and with the fiber direction in each monolayer being rotated with respect to the fiber direction in an adjacent monolayer.

2. The ballistic resistant sheet according to claim 1, wherein the areal density of a monolayer is between 20 and 60 g/m².

3. The ballistic resistant sheet according to claim 1, wherein the monolayer comprises at most 18.5 mass % of the matrix material.

4. The ballistic resistant sheet according to claim 1 wherein the unidirectionally oriented reinforcing fibers or yarns have a tensile strength of between 3.6 and 4.3 GPa.

5. The ballistic resistant sheet according to claim 1 wherein the unidirectionally oriented reinforcing fibers or yarns are highly-drawn polyethylene fibers.

6. The ballistic resistant sheet according to claim 1 wherein the number of monolayers is at most 10.

7. The ballistic resistance sheet of claim 1, wherein the diameter of a single filament in the reinforcing fibers or yarns is at most 2 denier.

8. Ballistic resistant article comprising between 10 and 250 of the ballistic resistant sheets according to claim 1.

9. Protective garment, such as a bullet resistant vest, comprising the ballistic resistant sheet of claim 1.

10. Use of the ballistic resistance sheet according to claim 1 in a ballistic resistant article.
